(19) United States
(12) Patent Application Publication
(10) Pub. No.: US 2007/0267792 A1
(43) Pub. Date: Nov. 22, 2007

(54) Sigma-springs for suspension systems

(76) Inventor: Salah Ahmed Mohamed Elmoselhy, Cairo (EG)

Correspondence Address: Salah Ahmed Elmoselhy, 6 Zerabden St., Syda Zenab, Cairo, 11461, EG

(21) Appl. No.: 11/709,903

(22) Filed: Feb. 21, 2007

Related U.S. Application Data
(63) Continuation of application No. PCT/EG05/00025, filed on Aug. 13, 2005.

(51) Int. Cl. B60G 13/18; F16F 1/00

(52) U.S. Cl. 267/195; 267/165

(57) ABSTRACT

Sigma-spring can be used as a passive vehicle suspension system of built-in damping, a passive vehicle suspension system with hydraulic damper, a semi-active vehicle suspension system of two opposite Sigma-springs (10,11) of built-in damping, or a semi-active vehicle suspension system of two opposite Sigma-springs (10,11) penetrated at line of external loading by hydraulic damper (12). The Sigma-spring is a spring of a special Sigma-shape above which mass can be suspended vertically while under static or dynamic loading conditions. The outer two arms of the Sigma-shape of the spring are inclined such that to be horizontal while fully loaded ensuring safe compression pattern. The Sigma-shape has two opposite sets of turns of different sizes one of small radius of curvature at the side of line of the applied external load and the opposite one has large radius of curvature in order to maximize spring vertical deflection capability. Thickness throughout the Sigma-spring developed length is graduated in order to minimize induced stresses, weight, and cost. Stiffness of the Sigma-spring can be nonlinear in order to provide improved vibration isolation and can be adjusted for same compact space allowance through increasing or decreasing its number of turns. The Sigma-spring can be made of Polymeric Matrix Composite of resin strengthened at nano-scale by nanometer-sized powder E-glass fibers. Moreover, the Sigma-spring can be made of Metallic Matrix Composite or of whole metallic monolithic material.

### FIELD OF THE INVENTION

This invention relates generally to spring of innovative optimized shape that may be fabricated from polymeric matrix composites modified at nano-structure, metal matrix composite, or monolithic material.

Particularly, the invention relates to suspension systems, vehicle suspension systems, and vehicle dynamics. The invention also relates to damping and structural mechanics. In addition, the invention relates to applications in Micro-Electro Mechanical Systems (MEMS) and at the nano-level in Nano-Electro Mechanical Systems (NEMS).

### DESCRIPTION OF THE PRIOR ART

Originally, a publication by Curtis et al., patent number U.S. Pat. No. 3,815,887, demonstrated in 1974 a plastic spring. The Curtis's patent describes a thin wall hollow, corrugated plastic spring providing a telescopic effect of non-linear rate. The Curtis's plastic spring is made of Polypropylene and has primary utility in seating and reclining applications.

More recently, a publication by Doller et al., patent number U.S. Pat. No. 4,850,464, published in 1989 presented a roller clutch energizing spring with protected pleats. The Dolller's patent describes an accordion type roller clutch energizing spring taking advantage of the side thrust that occurs when a spring of that type without squared off end leaves is tipped in order to fit it into the pocket.

A publication by Rose et al., patent number U.S. Pat. No. 4,805,885, demonstrated in 1989 a sinuous spring. The Rose's patent describes a spring for a switch actuating assembly is of generally E-shape or sinuous configuration.

A publication by Spedding, patent number U.S. Pat. No. 5,013,013, published in 1991 showed spring assemblies. The Spedding's patent describes a zig-zag spring in the form of a strip of fiber-reinforced plastics material with limbs connected by reflex portions.

A publication by Miller, patent number U.S. Pat. No. 5,540,418, published in 1996 presented a foldable bed with collapsible sinuous springs. The Miller's patent describes a foldable bed is movable between an unfolded position, in which interconnected seat, cavity, and body sections are substantially horizontally aligned and of substantially uniform depth, and a folded position, in which the body section is horizontally disposed, the seat section is generally upright and extends between the body and seat sections.

A publication by Miller, patent number U.S. Pat. No. 5,535,460, demonstrated in 1996 a spring assembly for seating and bedding. The Miller's patent describes a runner wire useful useful with collapsible springs includes a plurality of generally parallel and generally aligned runner sections.

A publication by Sancaktar, E., and Gratton, M., entitled “Design, Analysis, and Optimization of Composite Leaf Springs for Light Vehicle Applications” published in Vol. S0263-8223(98)00136-6, (1999) by Elsevier Science Ltd., featured a design of a composite leaf spring for light vehicle applications. The Sancaktar's publication describes aspects of design and manufacturing of composite leaf springs as a replacement of the traditional steel semi-elliptic multi-leaf springs.

A publication by Sardou, M. A., and Ptricia, D., entitled “Light and Low Cost Composite Compression C-springs for Vehicle Suspension” published in Vol. 2000-01-0100, (2000) by The Society of Automotive Engineers (SAE), demonstrated a design of a composite spring of C-shape for vehicle suspension applications. The Sardou's publication describes aspects of design and manufacturing of composite C-springs as a replacement of both of the traditional steel semi-elliptic multi-leaf springs and the composite leaf springs.

While the art described above has advanced the art of springs design and structure, there is still a need for a spring provides superior deflection capability in compact space condition, contributes in vibration isolation, and provides controllable spring stiffness within the same compact space according to loading conditions while maintaining high strength-to-weight ratio, high load carrying capacity, lightweight, and low cost.

Prior art spring configurations and structures failed to strike such a superior balance of desired features. Prior art spring configurations and materials are believed to provide either demonstrated deflection capabilities with large space requirements and relatively high level of induced stresses or poor deflection capabilities with compact space requirements and relatively low level of induced stresses.

Curtis et al.'s invention, patent number U.S. Pat. No. 3,815,887, has drawbacks include low load carrying capacity because of unified thickness throughout spring length, and weak deflection capability in compact space condition.

Doller et al.'s invention, patent number U.S. Pat. No. 4,850,464, has drawbacks include large space requirements because of large side movement, and low load carrying capacity because of unified thickness throughout spring length.

Rose et al.'s invention, patent number U.S. Pat. No. 4,805,885, has drawbacks include unsafe compression pattern of outer-sections of the spring due to external loading at the free ends of outer-sections because the two outer arms of the spring are initially horizontal, weak deflection capability because the U-shape of the large radius of curvature of the spring is at the line of loading at the free ends of outer-sections, and no mentioning of how one can control stiffness of the spring through geometrical configuration of the spring at different loading levels.

Spedding's invention, patent number U.S. Pat. No. 5,013,013, has drawbacks include low load carrying capacity because of unified thickness throughout spring length, and weak deflection capability because of equal radius of curvature of all U-shapes of the spring.

Miller's invention, patent number U.S. Pat. No. 5,540,418, has drawbacks include low load carrying capacity because of unified thickness throughout spring length, and large space requirements.

Miller's invention, patent number U.S. Pat. No. 5,535,460, has drawbacks include weak deflection capability because the spring deflection capability depends on elastic tension strain in metallic wire which is in turn very limited, and large space requirements.

### IDENTIFICATION OF OBJECTS OF THE INVENTION

Accordingly, it is a primary object of the invention to provide a spring of superior deflection capability in compact space conditions.

It is another object of the invention to provide a contribution in vibration isolation of the said suspended mass.

Another object of the invention is to provide a nonlinear spring rate that increases as mass of the suspended load increases.

Another object of the invention is to provide controllable spring stiffness within the same compact space according to loading conditions.

Another object of the invention is to provide high strength-to-weight ratio.

Another object of the invention is to provide high load carrying capacity.

Another object of the invention is to exhibit low cost through simple design and low cost materials of constituents.

### BRIEF DESCRIPTION OF THE DRAWINGS

The objects, advantages and features of the invention will become more apparent by reference to the drawings that are appended hereto and wherein like numerals indicate like parts and wherein an illustrative embodiment of the invention is shown, of which:

FIG. 1/9 depicts an elevation view of Sigma-spring for passive suspension systems;

FIG. 2/9 depicts a sectional view A-A showing that the cross section throughout developed length of the said spring is a rectangular cross section;

FIG. 3/9 depicts a side view of the Sigma-spring as a passive suspension spring;

FIG. 4/9 depicts a plan view of the Sigma-spring as a passive suspension spring;

FIG. 5/9 depicts an elevation view of semi-active Sigma-spring of Built-in damping under light-to-mid loading;

FIG. 6/9 depicts an elevation view of semi-active Sigma-spring of Built-in damping under heavy loading;

FIG. 7/9 depicts an elevation view of semi-active Sigma-spring with hydraulic damper under light-to-mid loading;

FIG. 8/9 depicts an elevation view of semi-active Sigma-spring with hydraulic damper under heavy loading;

FIG. 9/9 depicts a sectional elevation view of passive Sigma-spring assembled with suspended mass of vehicle and vehicle tire.

### DETAILED DESCRIPTION OF THE INVENTION

The invention of Sigma-spring is dedicated to provide a superior deflection capability in compact space limitations. Moreover, the said spring can contribute in vibration isolation of the said suspended mass (8) while maintaining high strength to weight ratio. Furthermore, it can provide a nonlinear spring rate such that the spring rate increases as mass of the said suspended mass increases allowing less potential dynamic energy and consequently improved value of the said vibration isolation.

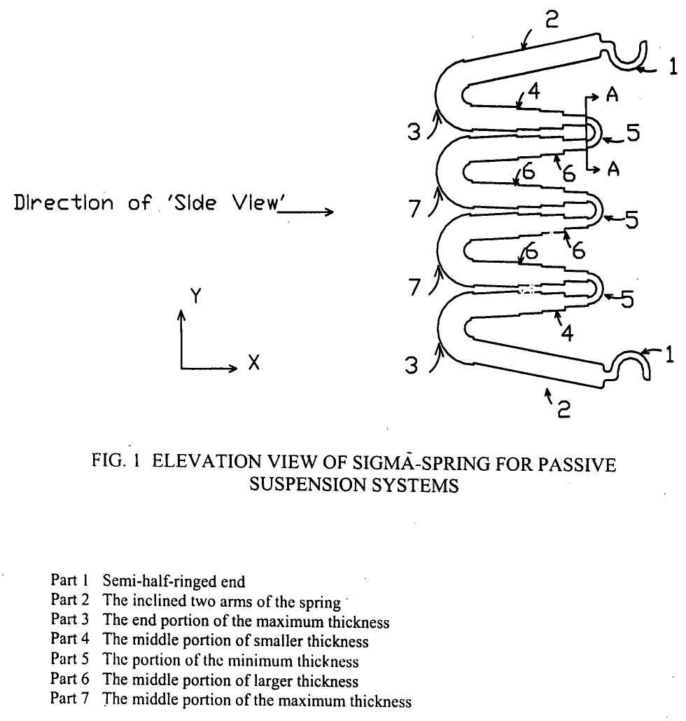

Referring now to FIG. 1/9, is an elevation view of the Sigma-spring shows continuous stream of the Capital Sigma-shape of the said spring and how rational is the graduated variation of thickness (4,5,6) throughout the developed length. In addition, in the course of the compression pattern of deflection of such shape, the portions of the maximum thickness (3,7) move away from each other in contrast with what they seem before loading. Such feature enables the possibility of increasing the thickness to the extreme extent at the critically stressed portions in order to extend fatigue life of the spring without affecting its compression pattern of deflection. Moreover, it shows the symmetric inclination of the two arms (2) of the spring which translate and rotate vertically being horizontal while fully loaded in order to ensure a safe compression pattern of the spring. It also features how easy is fixation of the said spring through resting of a protruding part of the said suspended mass such as a cylindrical pin (9) on the semi-half-ringed end (1) of one of the two inclined arms while the symmetric end of the other inclined arm is rested in a similar way on a dynamic excitation source. Such way of fixation can be applied in vehicle suspension systems. Furthermore, it shows smartness of the Sigma-shape that can have as much number of turns as the target stiffness requires. Also, it illustrates that the rectangular cross section is adopted throughout the developed length of the said spring because of its convenience for composite plies stacking, its reduced induced stresses due to its high moment of inertia, and its convenience for the lowest extreme value of height/width aspect ratio at the small radii of curvature of the said Sigma-shape.

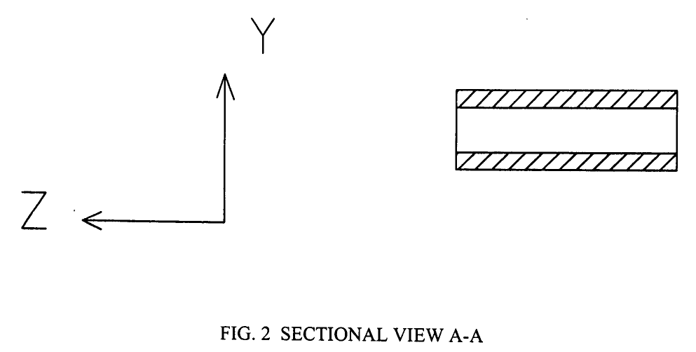

FIG. 2/9 is a sectional view A-A showing that the cross section throughout developed length of the Sigma-spring is a rectangular cross section for optimized performance in case of reinforced composite structure.

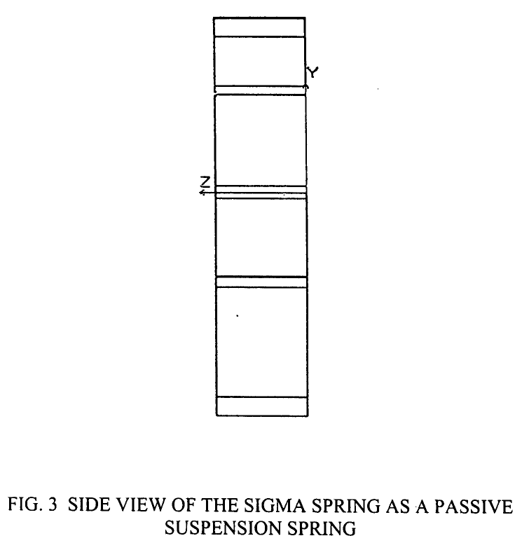

FIG. 3/9 is a side view of the Sigma-spring as a passive suspension spring. It demonstrates how compact is the depth of the spring along with its smart symmetric configuration.

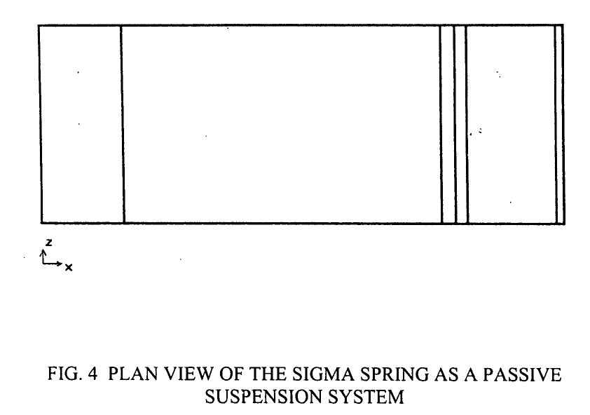

FIG. 4/9 illustrates a plan view of the Sigma-spring as a passive suspension spring. It shows how compact are the width requirements of the said spring.

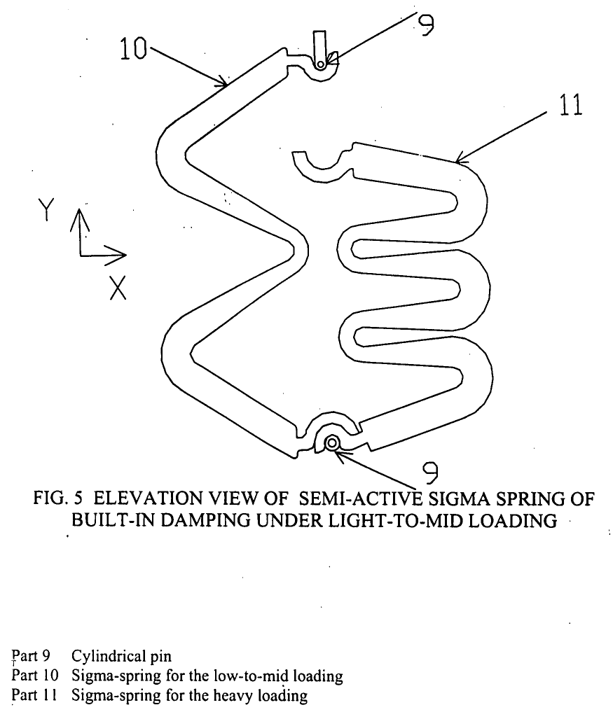

FIG. 5/9 demonstrates a semi-active suspension system of two opposite Sigma-springs (10,11) of Built-in damping at low-to-mid loading level. Such novel semi-active suspension system can be applied in vehicle suspension systems.

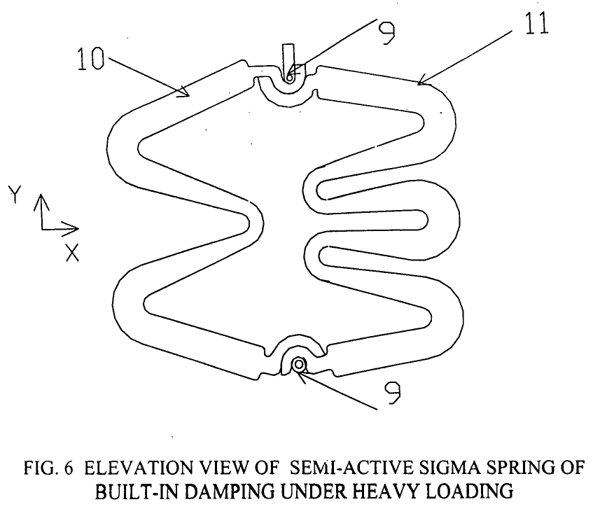

FIG. 6/9 illustrates the said semi-active suspension system at heavy loading level. It shows how smart is the deflection pattern of the said springs that saves space in an inward direction allowing the two said springs to deflect without interference.

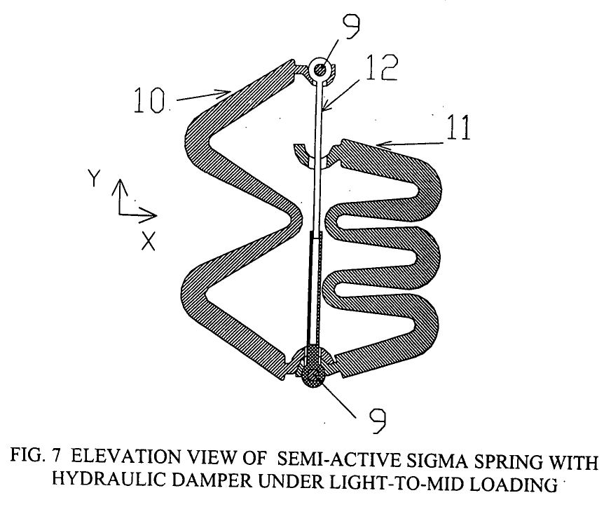

FIG. 7/9 demonstrates a semi-active suspension system of two opposite Sigma-springs with hydraulic damper at low-to-mid loading level. Such novel semi-active suspension system can be applied in vehicle suspension systems.

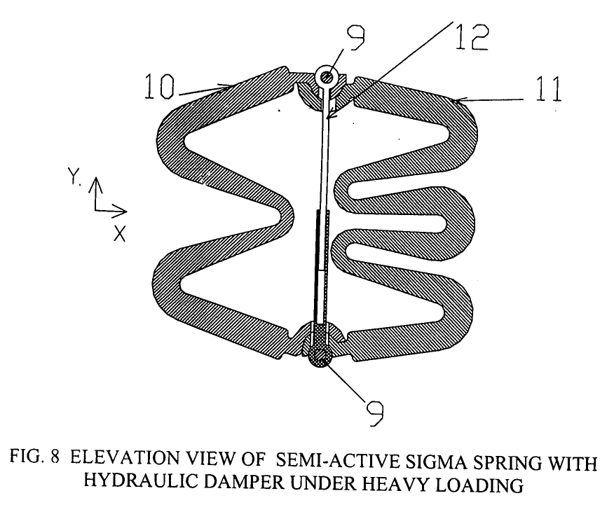

FIG. 8/9 illustrates the said semi-active suspension system at heavy loading level. It shows how smart is the deflection pattern of the said springs that saves space in an inward direction allowing the two said springs to deflect without interference.

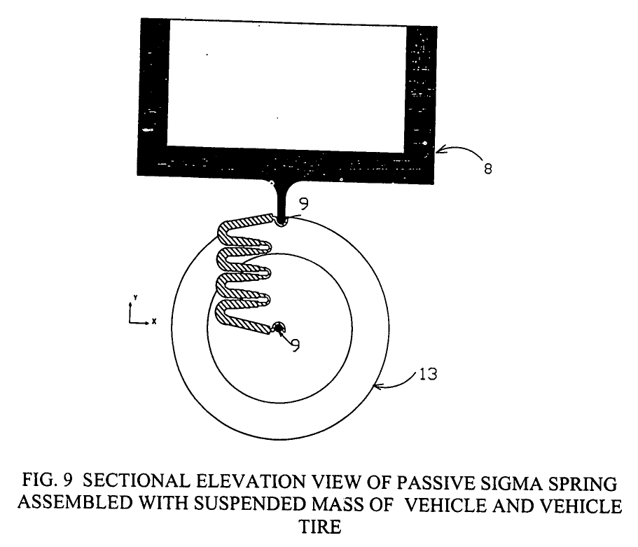

FIG. 9/9 illustrates a sectional elevation view of passive E-spring assembled with suspended mass of vehicle and vehicle tire (13) showing simplicity of assembly and possibility of adopting the Sigma-spring as a stand-alone spring providing springing and damping.

Sigma-spring can be composed of polymeric matrix composite of plies of aligned woven roving continuous E-glass fibers of volume percentage of 60% of composite structure impregnated in polyester resin strengthened at nano-scale either by nanometer-sized powder of mineral clay in order to get high structural strength to weight ratio or by nanometer-sized powder E-glass fibers in order to increase the deflection capability of the said spring while maintaining its structural strength with aggregate volume percentage of 39.5%. The polymeric matrix composite Sigma-spring can be fabricated by thoroughly mixing the said powder E-glass fibers of volume percentage of 7.5% of composite structure with polyester resin of volume percentage of 32% of composite structure and Cobalt-based catalyst (hardener) of volume percentage of 0.5% of composite structure. The aligned woven roving continuous E-glass fibers according to space allowance and target stiffness of the said spring are then cut to size and with symmetric and even number of plies in order to avoid presence of bending-stretching coupling in the laminate and in consequence in-plane loads will not generate bending and twisting curvatures. Next, an open mold of the desired shape of Sigma-shape is coated with paste wax in order to facilitate separation of finished Sigma-spring from the mold. Next, the said resin mixture is applied thoroughly to the said Sigma-glass fibers plies and laid-up in the said mold with stacking angles of ±45°. In order to ensure complete air removal and wet-out, serrated-rollers are used to compact the material against the mold to remove any entrapped air. Curing of resulted composite structure is achieved through chemical reaction in the resin because of the said catalyst.

Sigma-spring can be made of metal matrix composite of plies of aligned woven roving continuous E-glass fibers of volume percentage of 60% of composite structure impregnated in Nickel super-alloy resin of volume fraction of 40% of composite structure in order to extend fatigue life of such spring. The aligned woven roving continuous E-glass fibers according to space allowance and target stiffness of the said spring are cut to size and with symmetric and even number of plies in order to avoid presence of bending-stretching coupling in the laminate and in consequence in-plane loads will not generate bending and twisting curvatures. The metal matrix composite Sigma-spring can be fabricated by spraying the said metal matrix onto the fibers, which are supported on a foil, also made of the matrix material. The resulting ply is very porous, easily deformable, and suitable for cutting to the shape and size required for hot-pressing to the desired Sigma-shape. Next the said ply is manufactured repeatedly and laid-up with stacking angles of ±45° in a female open mold of the desired Sigma-shape until reaching the desired number of plies. The said plies are then consolidated by hot-pressing with a male mold of the said female open mold.

The stacking sequence of the said plies and the alignment of their fibers are selected optimally in order to maximize the strength of the spring while maintaining maximum deflection capability in a cost-effective way.

Sigma-spring can be made of whole metallic monolithic material such as cast alloy steel rather than composite material in order to avoid delamination of composite structure. Cast alloy steel Sigma-spring can be fabricated by injecting melted alloy steel in hot dies of the desired Sigma-shape.

What I claim as my invention is:

1. Sigma-shape has two opposite sets of turns of different sizes (3,5,7) one of small radius of curvature at the side of line of the applied external load (5) and the opposite one has large radius of curvature (3,7) in order to maximize spring vertical deflection capability.

2. Sigma-shape according to claim 1, is characterized by safe compression pattern of deflection such that the portions of large radius of curvature and large thickness (3,7) move away from each other in contrast with that they seem before loading.

3. Sigma-shape according to claim 2, has superior deflection capability that stiffness rate can be adjusted to the desired value in same compact space allowance through increasing or decreasing number of turns of the Sigma-spring.

4. Sigma-shape as claimed in claim 3, can be made of plies of aligned woven continuous E-glass fibers impregnated in polyester resin strengthened at nano-scale either by nanometer-sized powder of mineral clay in order to provide high structural strength to weight ratio along with contribution to vibration isolation of the suspended mass or by nanometer-sized powder E-glass fibers in order to increase the deflection capability of the said spring while maintaining its structural strength along with contribution in vibration isolation of the suspended mass (8) through internal damping of spring structure.

5. Sigma-shape according to claim 4, has a character of rising-rate spring rate such that its spring rate increases as mass of the said suspended mass (8) increases allowing less potential dynamic energy and consequently providing improved vibration isolation.

6. Sigma-shape according to claim 4, can be made of the same fibers material and same stacking sequence but of metal matrix such as Nickel super alloy rather than polyester in order to extend fatigue life of this spring.

7. Sigma-shape as claimed in claim 4, can be made of metallic monolithic material such as cast alloy steel rather than composite material in order to avoid delamination of composite structure.

8. Sigma-shape as claimed in claim 4, can be used as a self-damped semi-active vehicle suspension system that contains two opposite Sigma-springs (10,11) each of which has the same stiffness and has curved-end (1) as a seat for bearing load on each other and one of the two opposite Sigma-springs (10) is taller than the other (11) and acts at low-to-mid loading level whereas at heavy loading level deflects touching and consequently bearing on the other one.

9. Sigma-shape as claimed in claim 3, can be used as a hydraulically-damped semi-active vehicle suspension system that contains two opposite Sigma-springs (10, 11) penetrated at line of external loading by hydraulic damper (12) each of the two penetrated opposite Sigma-springs (10,11) has the same stiffness and has curved-end (1) as a seat for bearing load on each other and one of the two penetrated opposite springs (10) is taller than the other (11) and acts at low-to-mid loading level whereas at heavy loading level deflects touching and consequently bearing on the other one.

10. Sigma-shape as claimed in claim 1, can be used at the micro-level in Micro-Electrical Mechanical Systems (MEMS) and at the nano-level in Nano-Electrical Mechanical Systems (NEMS).
